(19) United States
(12) Patent Application Publication
(10) Pub. No.: US 2025/0158339 A1
(43) Pub. Date: May 15, 2025

(54) SIMPLIFIED POWER CONNECTORS

(71) Applicant: Apple Inc., Cupertino, CA (US)

(72) Inventor: Mahmoud R. Amini, Redwood City, CA (US)

(73) Assignee: Apple Inc., Cupertino, CA (US)

(21) Appl. No.: 18/943,699

(22) Filed: Nov. 11, 2024

Related U.S. Application Data
(60) Provisional application No. 63/548,212, filed on Nov. 12, 2023.
(60) Provisional application No. 63/575,723, filed on Apr. 6, 2024.

(51) Int. Cl. H01R 24/60; H01R 43/16

(52) U.S. Cl. CPC H01R 24/60; H01R 43/16

(57) ABSTRACT

Connector structures that can be readily manufactured and provide a reversible connection.

### CROSS-REFERENCES TO RELATED APPLICATIONS

This application claims the benefit of U.S. Provisional Applications No. 63/548,212, filed on Nov. 12, 2023, and No. 63/575,723, filed on Apr. 6, 2024, which are incorporated by reference.

### BACKGROUND

The number of types of electronic devices that are commercially available has increased tremendously the past few years and the rate of introduction of new devices shows no signs of abating. Devices such as tablet computers, laptop computers, all-in-one computers, desktop computers, cell phones, storage devices, wearable-computing devices, portable media players, portable computing devices, navigation systems, monitors, audio devices, remotes, adapters, and others have become ubiquitous.

Some of these electronic devices can receive data and power through cables that are connected to power adapters, host devices, or other data and power sources. These cables can have connector inserts at each end that can be inserted into a connector receptacle in electronic devices. The connector receptacles can include contacts that can form electrical connections with corresponding contacts in the connector inserts.

In some devices, it can be desirable to have a receptacle that is only for charging. That is, an electronic device can be designed to be charged over a cable while data is either not communicated by the electronic device or is communicated wirelessly. Accordingly, it can be desirable to provide connector receptacles that are specifically made to receive power from a charging device, such as a power adapter, host device, or other charging device.

Various electronic devices can be manufactured in very high volumes. To meet these high volumes, it can be desirable that these connector receptacles be readily manufactured. It can also be desirable that they be manufacturable with a reduced amount of resources, and in a manner that reduces an impact on the environment.

Connections to these connector receptacles can be made with connector inserts at an end of a cable. It can be desirable that a connection can be made with a connector insert independent of an orientation of the connector insert when the connector insert is inserted into the connector receptacle.

Thus, what is needed are connector structures that can be readily manufactured and provide a reversible connection.

### SUMMARY

Accordingly, embodiments of the present invention can provide connector structures that can be readily manufactured and provide a reversible connection. An illustrated embodiment of the present invention can provide a connector structure that can be readily manufactured by providing a first plurality of contacts for a top side and a second plurality of contacts for a bottom side of a tongue for a connector receptacle where the first plurality of contacts and the second plurality of contacts are formed using a single reel. That is, each of a first plurality of contacts for a top side and each of a second plurality of contacts for a bottom side of a tongue can be stamped from a single piece of metal that is attached to a single carrier. This can reduce the number of reels and the number of stamping steps that are needed to manufacture a connector receptacle, thereby conserving resources and reducing environmental impact.

These and other embodiments of the present invention can exploit the fact that not all contacts are needed on a connector receptacle that is used to convey power and is not used to convey data. The absence of data contacts can allow pairs of power contacts and pairs of ground contacts to be stamped together from a single reel. The contacts in each pair of contacts can be joined together by one or more joining pieces. The joining pieces can be bent such that the pairs of contacts are folded. The contacts in each pair of contacts can be aligned with each other such that a first contact in each pair can be on a top side and a second contact in each pair can be on a bottom side of a tongue of the connector receptacle after the tongue is molded. For example, the second contact can be aligned directly below the first contact on the tongue. The contacts in each pair of contacts can be soldered, spot or laser welded, or otherwise attached to each other. The connections formed by the joining pieces and this attachment can allow each pair of contacts to terminate in a single end. The single ends can be surface-mount contacting portions, they can be through-hole contacting portions, or they can be other type of terminations. These techniques can provide power and ground contacts that are capable of providing a full amount of power in compliance with USB Type-C or other specifications. For example, connector receptacles provided by embodiments of the present invention can provide 240 Watts of power.

These and other embodiments of the present invention can provide a plurality of contacts for a connector receptacle. The plurality of contacts can include a first plurality of contacts to be positioned on a top side of a tongue of the connector receptacle and a second plurality of contacts to be positioned on a bottom side of the tongue of the connector receptacle. The first plurality of contacts, the second plurality of contacts, and a carrier can be stamped from a sheet of metal. Pairs of contacts can include each include a first contact in the first plurality of contacts and a second contact in the second plurality of contacts. The first and second contact in each pair can be joined by one or more joining pieces. The joining pieces can be folded such that after molding, the second contact in each pair can be below, for example directly below, the first contact of the pair. The first contact in each pair can then be soldered, spot or laser welded, or otherwise attached to the second contact in each pair. A frame can be positioned around a front and sides of the various contacts and soldered, spot or laser welded, or otherwise attached to joining pieces of one or more pairs of contacts. The frame can provide side ground contacts and structural integrity for the tongue of the connector receptacle. A molding for the tongue and housing can be formed over the frame, the first plurality of contacts, and the second plurality of contacts. This molding can be done in a single step, though an optional initial mold can be used to align and help hold contact in place relative to each other. The carrier can be detached after molding.

These and other embodiments of the present invention can provide contacts that are the same or functionally similar on a top side as those on a bottom side of a tongue of the connector receptacle. This can help to provide a connector receptacle that provides the same functionality independent of an orientation of a connector insert plugged into the connector receptacle. This can provide a connection to an electronic device that is reversible.

As an example of this reversibility, these and other embodiments of the present invention can provide Universal Serial Bus (USB), USB Type-C connector receptacles. The contacts can be reduced to a first plurality of contacts including two ground contacts, two VBUS contacts, and a CC1 contact on a top side of a tongue and two ground contacts, two VBUS contacts, and a CC2 contact on a bottom side of the tongue of a connector receptacle. In another example the contacts can be reduced to a first plurality of contacts including two ground contacts, two VBUS contacts, a CC1 contact, and a pair of connected D+ and D− pins on a top side of a tongue and two ground contacts, two VBUS contacts, a CC2 contact, and a pair of connected D+ and D− pins on a bottom side of the tongue of a connector receptacle.

These and other embodiments of the present invention can include a center ground plate for noise and grounding purposes, as well as to improve structural integrity. The center ground plate can include a number of openings and cutouts to allow the various joining pieces and welded or soldered portions between contacts to pass through. These and other embodiments of the present invention can also include a frame around a front and sides. This frame can provide side ground contacts for the tongue and can also help to improve structural integrity.

Embodiments of the present invention can provide connector structures for connector receptacles that are compliant with various standards such as USB, USB Type-C, High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future.

In these and other embodiments of the present invention, contacts, ground pads, and other conductive portions of a connector receptacle can be formed by stamping, progressive stamping, forging, metal-injection molding, deep drawing, machining, micro-machining, computer-numerically controlled (CNC) machining, screw-machining, 3-D printing, clinching, or other manufacturing process. The conductive portions can be formed of stainless steel, steel, copper, copper-titanium, phosphor-bronze, brass, nickel gold, copper-nickel, silicon alloys, or other material or combination of materials. They can be plated or coated with nickel, gold, or other material.

The nonconductive portions, such as tongue moldings and other structures, can be formed using insert molding, injection molding, or other molding, 3-D printing, machining, or other manufacturing process. The nonconductive portions can be formed of silicon or silicone, polyimide, glass nylon, polycarbonate, rubber, hard rubber, plastic, nylon, liquid-crystal polymers (LCPs), ceramics, thermoplastic elastomers (TPE) or other nonconductive material or combination of materials.

Embodiments of the present invention can provide connector receptacles that can be located in various types of devices, such as tablet computers, laptop computers, desktop computers, all-in-one computers, cell phones, storage devices, wearable-computing devices, portable computing devices, portable media players, navigation systems, monitors, remotes, adapters, and other devices.

While embodiments of the present invention are well-suited to use in connector receptacles, these and other embodiments of the present invention can be utilized in connector inserts and other types of connectors as well.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates an electronic system that can be improved by the incorporation of embodiments of the present invention;

FIG. 2 illustrates a tongue for a connector receptacle according to an embodiment of the present invention;

FIG. 3 is a top view of the tongue of FIG. 2;

FIG. 4 is an oblique view of the tongue of FIG. 2;

FIG. 5 illustrates a plurality of contacts according to an embodiment of the present invention;

FIG. 6 is an exploded view of the tongue shown in FIG. 2;

FIG. 7 illustrates a portion of the tongue shown in FIG. 2;

FIG. 8 is an oblique view of a tongue for a connector receptacle according to an embodiment of the present invention;

FIG. 9 illustrates a portion of the tongue shown in FIG. 8;

FIG. 10 illustrates a portion of the tongue shown in FIG. 8;

FIG. 11 illustrates a tongue for a connector receptacle that includes a center ground plate according to an embodiment of the present invention;

FIG. 12 illustrates a portion of the tongue of FIG. 11;

FIG. 13A and FIG. 13B illustrate a tongue for a connector receptacle according to an embodiment of the present invention;

FIG. 14 is an exploded view of the tongue shown in FIG. 13;

FIG. 15 illustrates a plurality of contacts according to an embodiment of the present invention;

FIG. 16 illustrates the plurality of contacts of FIG. 15 following further processing according to an embodiment of the present invention;

FIG. 17 is an exploded view of a portion of the tongue shown in FIG. 13; and

FIG. 18 illustrates a portion of the tongue of FIG. 13.

### DESCRIPTION OF ILLUSTRATIVE EMBODIMENTS

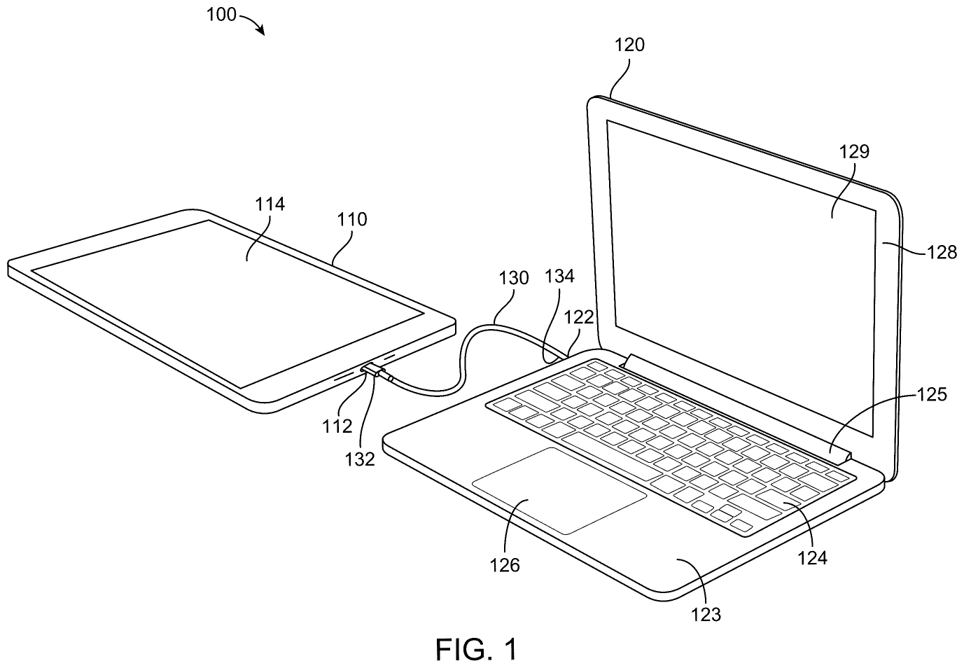

FIG. 1 illustrates an electronic system that can be improved by the incorporation of embodiments of the present invention. Electronic system 100 can include handheld computing device 110 and portable computing device 120. Handheld computing device 110 can include connector receptacle 112 and screen 114. Portable computing device 120 can include base 123 supporting keyboard 124 and touchpad 126. Portable computing device 120 can further include lid 128 supporting screen 129. Base 123 can be joined to lid 128 by hinge 125. Base 123 can include connector receptacle 122.

Cable 130 can convey power and data between handheld computing device 110 and portable computing device 120. Cable 130 can include a connector insert 132 at a first end that can be plugged into connector receptacle 112 of handheld computing device 110. Cable 130 can further include connector insert 134 the can be plugged into connector receptacle 122 of portable computing device 120.

In this example, electronic system 100 is shown as including handheld computing device 110 and portable computing device 120. In these and other embodiments of the present invention, electronic system 100 can include other types of devices. Also, while handheld computing device 110 is shown as a table computer and portable computing device 120 is shown as a laptop computer, either or both can be other types of devices, such as desktop computers, all-in-one computers, cell phones, storage devices, wearable-computing devices, audio devices, storage cases for audio devices, portable computing devices, portable media players, navigation systems, audio devices, monitors, remotes, adapters, and other devices.

Embodiments of the present invention can provide connector receptacles, such as connector receptacle 112 and connector receptacle 122, and connector inserts, such as connector insert 132 and connector insert 134, that are compliant with various standards such as Universal Serial Bus (USB), USB Type-C, High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future.

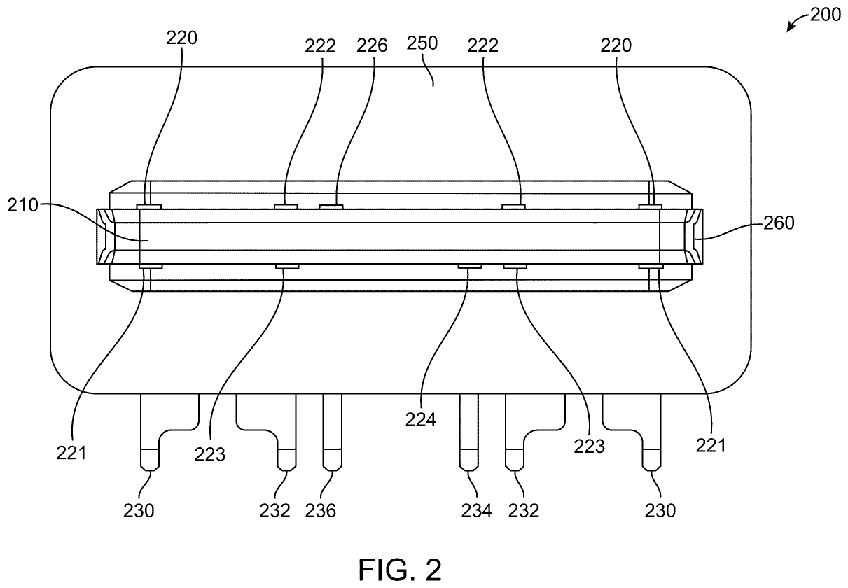

FIG. 2 illustrates a tongue for a connector receptacle according to an embodiment of the present invention. This figure, as with the other included figures, are shown for illustrative purposes and do not limit either the possible embodiments of the present invention or the claims.

Connector receptacle 200 can be used as connector receptacle 112, connector receptacle 122 (both shown in FIG. 1), or another connector receptacle according to an embodiment of the present invention. Tongue 210 can include a first plurality of contacts on a top side and a second plurality of contacts on a bottom side. Specifically, tongue 210 can include ground contacts 220, VBUS contacts 222, and CC1 contact 226 on a top side and ground contacts 221, VBUS contacts 223, and CC2 contact 224 on a bottom side. This contact arrangement can be rotationally symmetrical such that a corresponding connector insert can be inserted in either of two orientations that are rotated 180 degrees relative to each other, that is, connector receptacle 200 can provide a reversible connection. The use of two ground contacts 220 and two VBUS contacts 222 can allow connector receptacle 200 to provide or receive 240 Watts of power for a full power range for the USB Type-C specification.

CC1 contact 226 and CC2 contact 224 can be connection detect contacts that are in compliance with USB Type-C, though these contacts can be other contacts in other embodiments of the present invention. Tongue 210 can further support side ground contacts 260 on each end. Tongue 210 can be supported by housing 250. Ground contacts 220 and 221 can terminate at single ends 230, while VBUS contacts 222 and 223 can terminate at single ends 232. CC1 contact 226 can terminate in end 236, while CC2 contact 224 can terminate in end 234. Some or all of ends 230, 232, 234, and 236 can be surface-mount contacting portions, through-hole contacting portions, or other type of end.

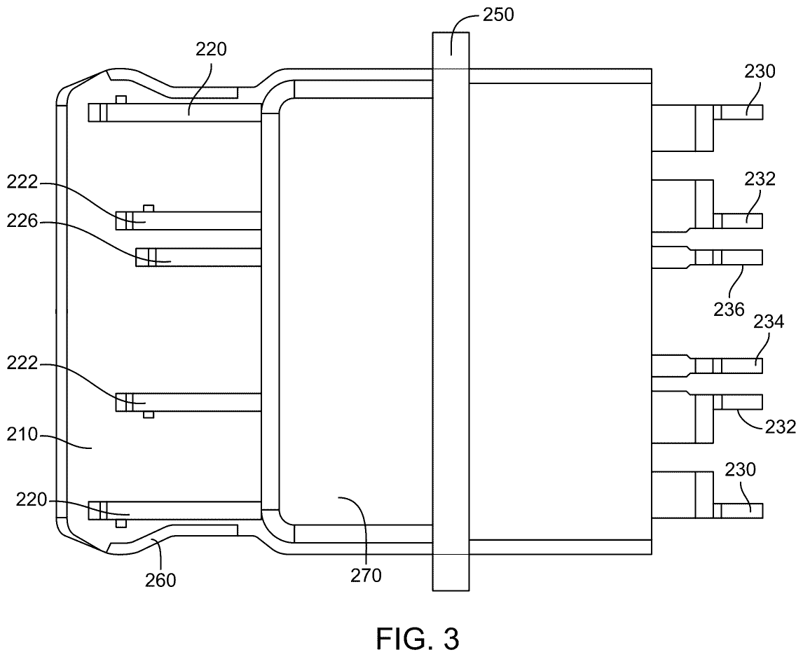

FIG. 3 is a top view of the tongue of FIG. 2. The illustrated top side of tongue 210 for connector receptacle 200 can support ground contacts 220, VBUS contacts 222, and CC1 contact 226. Ground contact ends 230, VBUS contact ends 232, CC1 contact end 236, and CC2 contact end 234 can extend from a back of housing 250. These ends are shown here as surface-mount contacting portions, though they can be through-hole contacting portions or other type of end. Tongue 210 can also support side ground contacts 260.

These and other embodiments of the present invention can simplify tongue 210 further by omitting ground pads that are often positioned such that the contacts are between the ground pads and a front edge of the tongue. In this example, region 270 does not include a ground contact on this top side or at a corresponding position on a bottom side of tongue 210. This omission can possible since tongue 210 does not include data contacts in this example. This can eliminate the need to form and implement these ground pads, which can conserve resources and reduce environmental impact. In these and other embodiments of the present invention, region 270 can include a ground pad on a top side, bottom side, or both a top side and a bottom side of tongue 210.

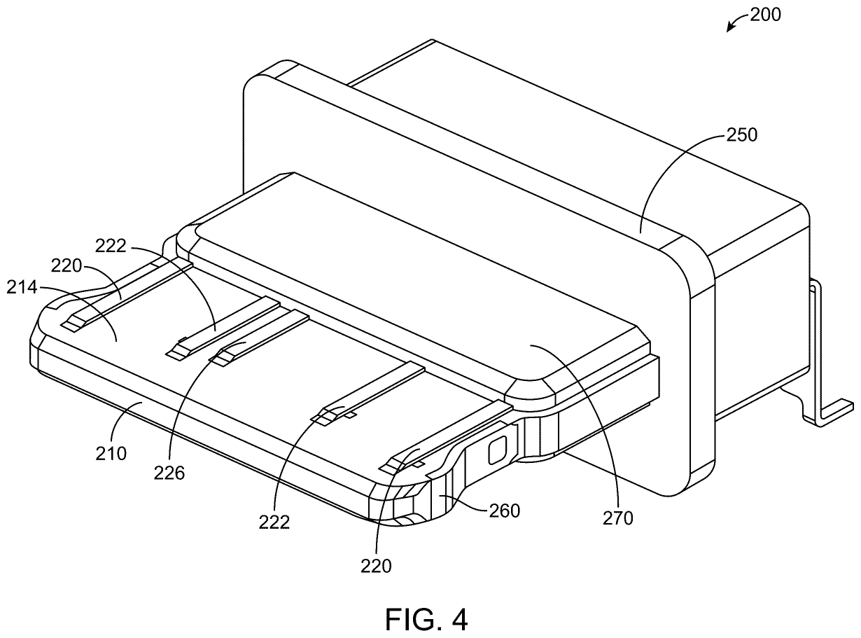

FIG. 4 is an oblique view of the tongue of FIG. 2. The illustrated top side of tongue 210 for connector receptacle 200 can support ground contacts 220, VBUS contacts 222, and CC1 contact 226. Ground pads can be omitted at region 270 as well as at a corresponding location on a bottom side of tongue 210. Tongue 210 can further support side ground contacts 260. Housing 250 can support tongue 210.

Tongue 210, along with housing 250, can be molded in various ways. In this example, tongue 210 and housing 250 can be molded as molding 214 as a single shot mold, using injection molding or other type of molding process.

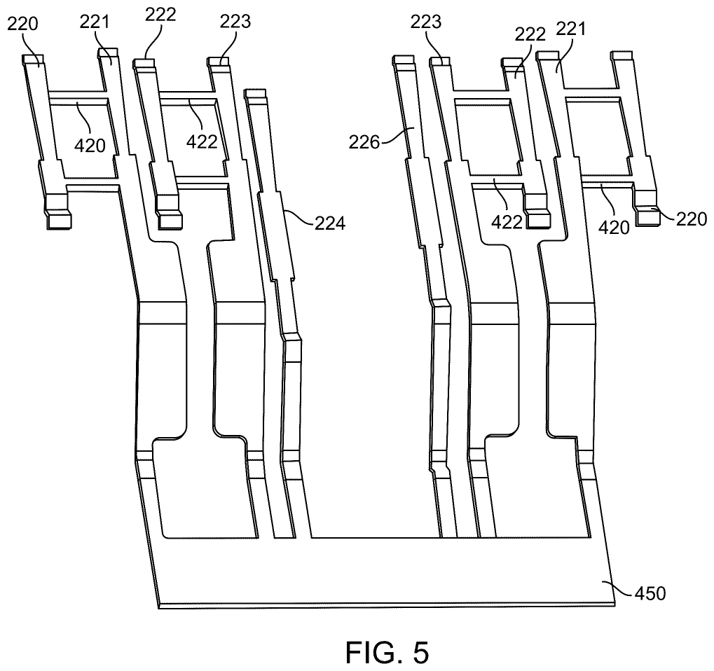

FIG. 5 illustrates a plurality of contacts according to an embodiment of the present invention. These and other embodiments of the present invention can exploit the fact that several contacts, such as data contacts including transmit and receive pairs, as well as USB contacts and connector power contacts, are omitted from connector receptacle 200 (shown in FIG. 2.) This free space can allow contacts pairs for power and ground contacts on a top and bottom of a tongue for a connector receptacle to be formed in a line next to each other. For example, ground contacts 221 for a bottom side of tongue 210 (shown in FIG. 2) can be formed adjacent to ground contacts 220 for a top side of tongue 210. Ground contacts 221 can be joined to ground contacts 220 via one or more joining pieces 420. Similarly, VBUS contacts 223 for a bottom side of tongue 210 (shown in FIG. 2) can be formed adjacent to VBUS contacts 222 for a top side of tongue 210. VBUS contacts 223 can be joined to VBUS contacts 222 via one or more joining pieces 422. Each of these contacts, along with CC1 contact 226 and CC2 contact 224, can be attached to carrier 450. This can allow the manufacturing of tongue 210 using a single reel. That is, carrier 450 can be pulled from a single reel of sheet metal, which can be stainless steel or other material. All the contacts shown as being on a top side and a bottom side of tongue 210 can be attached to carrier 450 and can be stamped from the same piece of metal. Once these contacts have been stamped, they can be folded, soldered, spot or laser welded, or otherwise attached, and tongue 210 can be molded. An example is shown in the following figures.

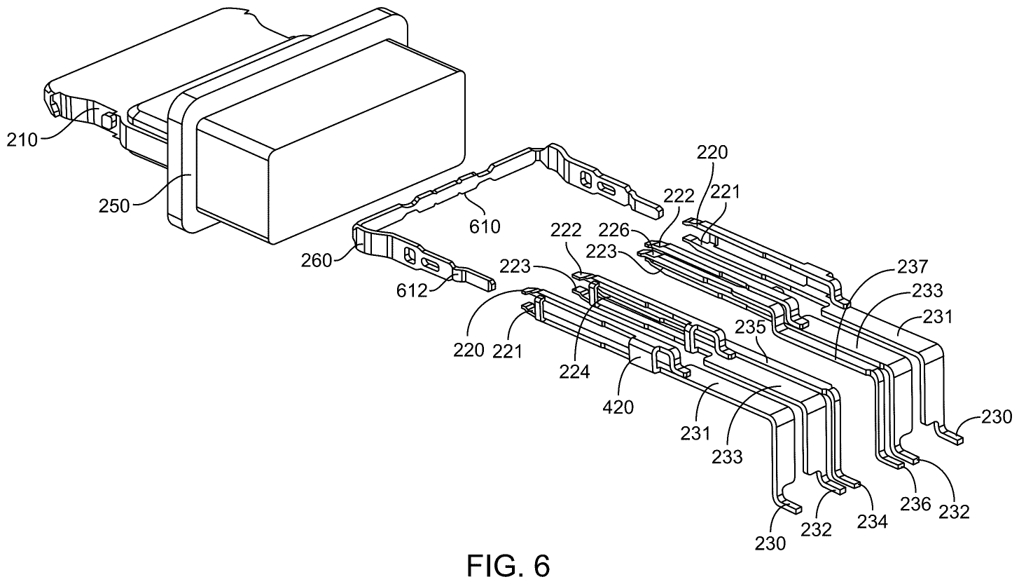

FIG. 6 is an exploded view of the tongue shown in FIG. 2. Contacts for a top side of tongue 210 can include ground contacts 220, VBUS contacts 222, and CC1 contact 226. Contacts for a bottom side of tongue 210 can include ground contacts 221, VBUS contacts 223, and CC2 contact 224. Each pair of ground contacts 220 and ground contacts 221 can include extensions 231 and can terminate in an end 230. Each pair of VBUS contacts 222 and VBUS contacts 223 can include extensions 233 and can terminate in an end 232. CC1 contact 226 can include extension 237 and can terminate in end 236. CC2 contact 224 can include extension 235 and can terminate in end 234. Each of the extensions 231, 233, 237, and 235 can lie in the same plane, that is, they can be planar. Each end 230, 232, 236, and 234 can be a surface-mount contacting portion and can be separated from carrier 450 (shown in FIG. 5) after tongue 210 and housing 250 are molded.

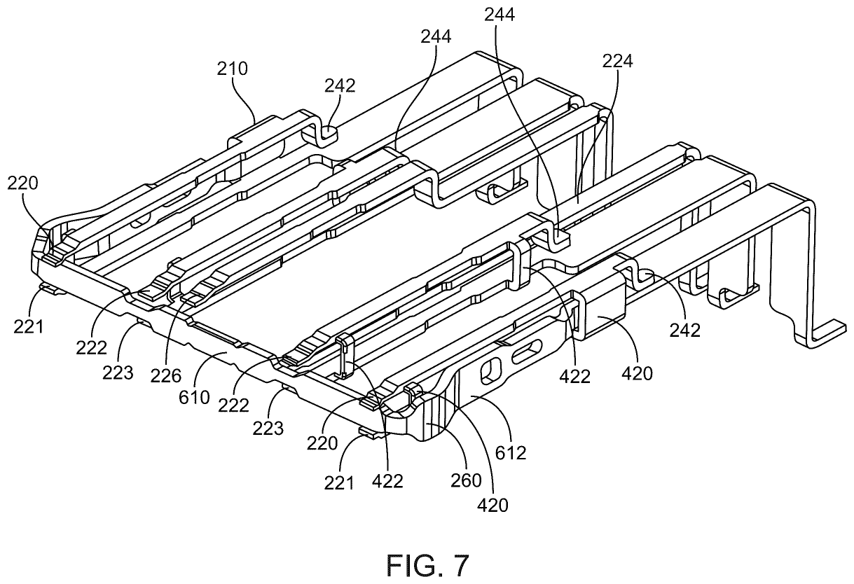

Frame 610 can include arms 612. Arms 612 can be attached to one or more joining pieces 420 as shown in FIG. 7. Frame 610 can provide side ground contacts 260. Frame 610 can provide grounding and mechanical reinforcement for tongue 210. Tongue 210 and housing 250 can then be molded. This molding can be a single shot mold, for example using injection molding or other molding technique.

FIG. 7 illustrates a portion of the tongue shown in FIG. 2. Contacts for a top side of tongue 210 can include ground contacts 220, VBUS contacts 222, and CC1 contact 226. Contacts for a bottom side of tongue 210 can include ground contacts 221, VBUS contacts 223, and CC2 contact 224. These contacts can be formed from a single reel and can be attached to a single carrier 450 as shown in FIG. 5. After stamping, ground contacts 220 can be folded over at joining pieces 420 such that they are over ground contacts 221. Ground contacts 220 can be soldered, spot or laser welded, or otherwise attached to ground contacts 221 at locations 242. Similarly, VBUS contacts 222 can be folded over at joining pieces 422 such that they are over VBUS contacts 223. VBUS contacts 222 can be soldered, spot or laser welded, or otherwise attached to VBUS contacts 223 at locations 244. Arms 612 of frame 610 can be soldered, spot or laser welded, or otherwise attached to one or more joining pieces 420. Frame 610 can include side ground contacts 260.

In this example, tongue 210 and housing 250 can be molded in a single shot. In these and other embodiments of the present invention, tongue 210 and housing 250 can be formed using more than one shot. For example, a first shot can be used to form a molding portion to align and hold the various contacts in position during the formation of tongue 210 and housing 250. An example is shown in the following figure.

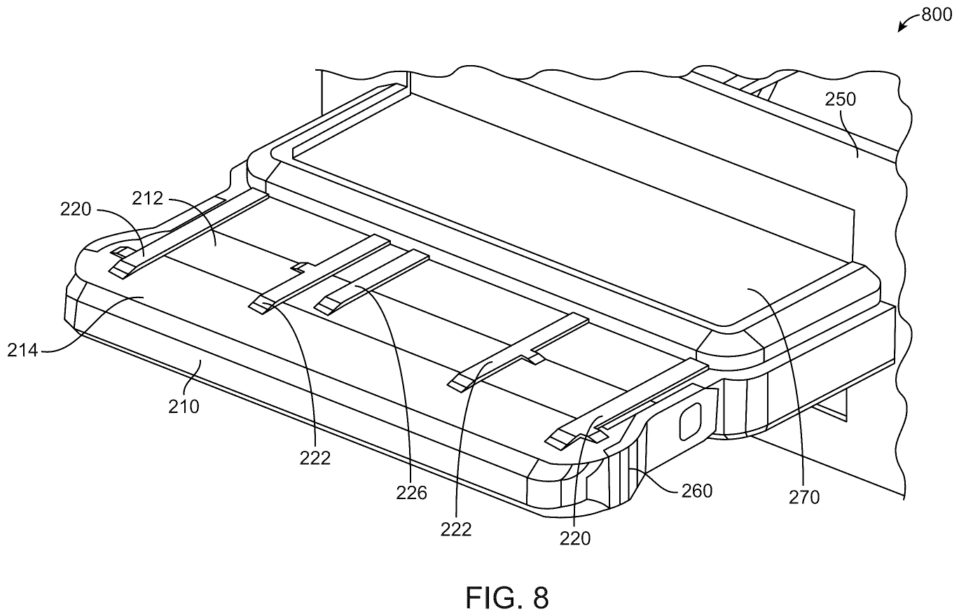

FIG. 8 is an oblique view of a tongue for a connector receptacle according to an embodiment of the present invention. Connector receptacle 800 can be used as connector receptacle 112, connector receptacle 122 (both shown in FIG. 1), or another connector receptacle according to an embodiment of the present invention. Connector receptacle 800 can be the same as or similar to connector receptacle 200 (shown in FIG. 2.) The contact arrangement of connector receptacle 800 can be rotationally symmetrical such that a corresponding connector insert can be inserted in either of two orientations that are rotated 180 degrees relative to each other, that is, connector receptacle 800 can provide a reversible connection. The use of two ground contacts 220 and two VBUS contacts 222 can allow connector receptacle 800 to provide or receive 240 Watts of power for a full power range for the USB Type-C specification.

The illustrated top side of tongue 210 for connector receptacle 800 can support ground contacts 220, VBUS contacts 222, and CC1 contact 226. Ground pads can be omitted at region 270 as well as at a corresponding location on a bottom side of tongue 210. Tongue 210 can further support side ground contacts 260. Housing 250 can support tongue 210.

Tongue 210, along with housing 250, can be molded in various ways. In this example, molding 212 can be formed and used to align and help the various contacts in place during the formation of molding 214, which can form the remaining portions of tongue 210 and housing 250. An example of this is shown in the following figure.

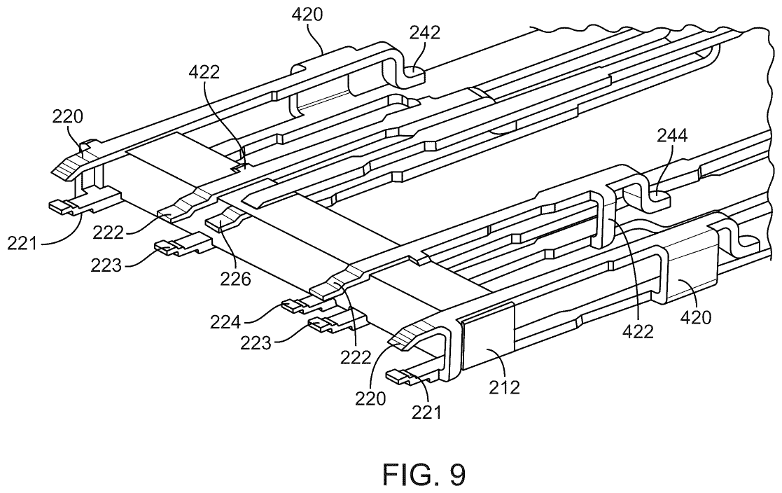

FIG. 9 illustrates a portion of the tongue shown in FIG. 8. Contacts for a top side of tongue 210 can include ground contacts 220, VBUS contacts 222, and CC1 contact 226. Contacts for a bottom side of tongue 210 can include ground contacts 221, VBUS contacts 223, and CC2 contact 224. These contacts can be formed from a single reel and can be attached to a single carrier 450 as shown in FIG. 5. After stamping, molding 212 can be formed around portions of the various contacts. Molding 212 can help to align and hold the various contacts in place during the formation of molding 214 to form tongue 210 and housing 250 (shown in FIG. 8.) Ground contacts 220 can be folded over at joining pieces 420 such that they are over ground contacts 221. Ground contacts 220 can be soldered, spot or laser welded, or otherwise attached to ground contacts 221 at locations 242. Similarly, VBUS contacts 222 can be folded over at joining pieces 422 such that they are over VBUS contacts 223. VBUS contacts 222 can be soldered, spot or laser welded, or otherwise attached to VBUS contacts 223 at locations 244.

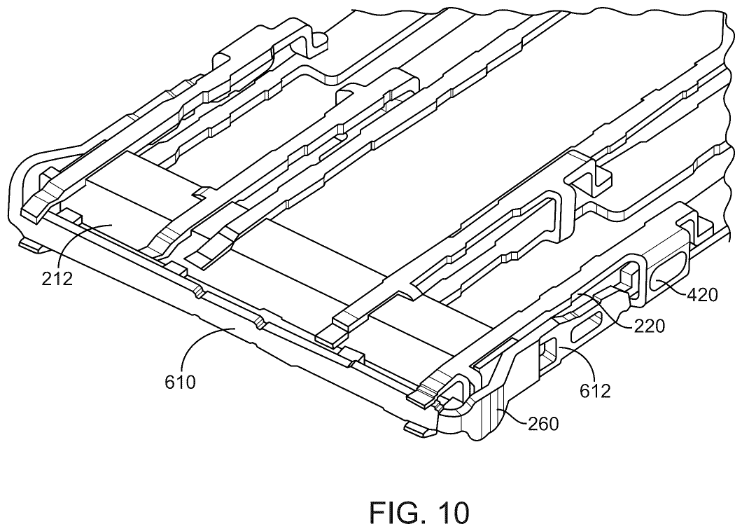

FIG. 10 illustrates a portion of the tongue shown in FIG. 8. Molding 212 can be formed. Arms 612 of frame 610 can be attached to one or more joining pieces 420 to secure frame 610 in place such that frame 610 provides a ground path between the ground contacts 220. Frame 610 can include side ground contacts 260.

These and other embodiments of the present invention can include center ground planes in tongue 210. Such a ground plane can help to reduce noise and provide mechanical reinforcement for tongue 210. An example is shown in the following figure.

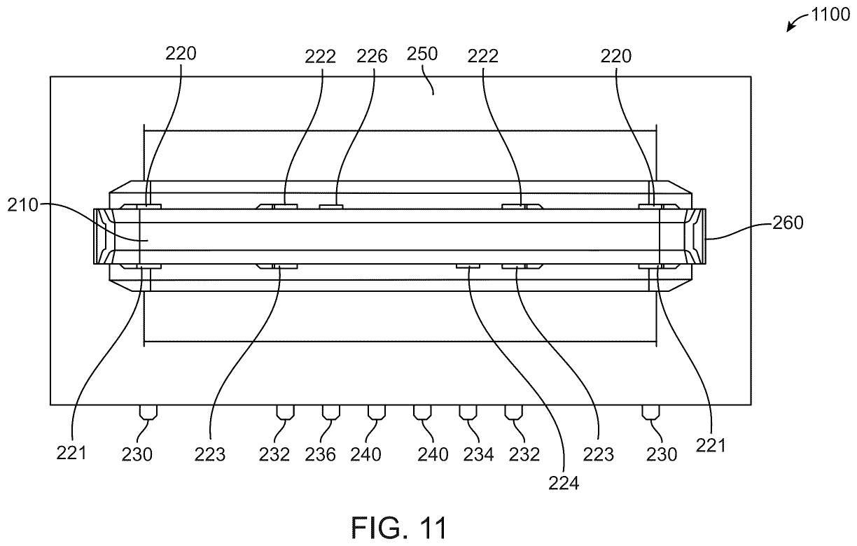

FIG. 11 illustrates a tongue for a connector receptacle that includes a center ground plate according to an embodiment of the present invention. Connector receptacle 1100 can be used as connector receptacle 112, connector receptacle 122 (both shown in FIG. 1), or another connector receptacle according to an embodiment of the present invention. Connector receptacle 1100 can be the same as or similar to connector receptacle 200 (shown in FIG. 2) and connector receptacle 800 (shown in FIG. 8.) Tongue 210 can include a first plurality of contacts on a top side and a second plurality of contacts on a bottom side. Specifically, tongue 210 can include ground contacts 220, VBUS contacts 222, and CC1 contact 226 on a top side and ground contacts 221, VBUS contacts 223, and CC2 contact 224 on a bottom side. This contact arrangement can be rotationally symmetrical such that a corresponding connector insert can be inserted in either of two orientations that are rotated 180 degrees relative to each other, that is, connector receptacle 1100 can provide a reversible connection. The use of two ground contacts 220 and two VBUS contacts 222 can allow connector receptacle 1100 to provide or receive 240 Watts of power for a full power range for the USB Type-C specification.

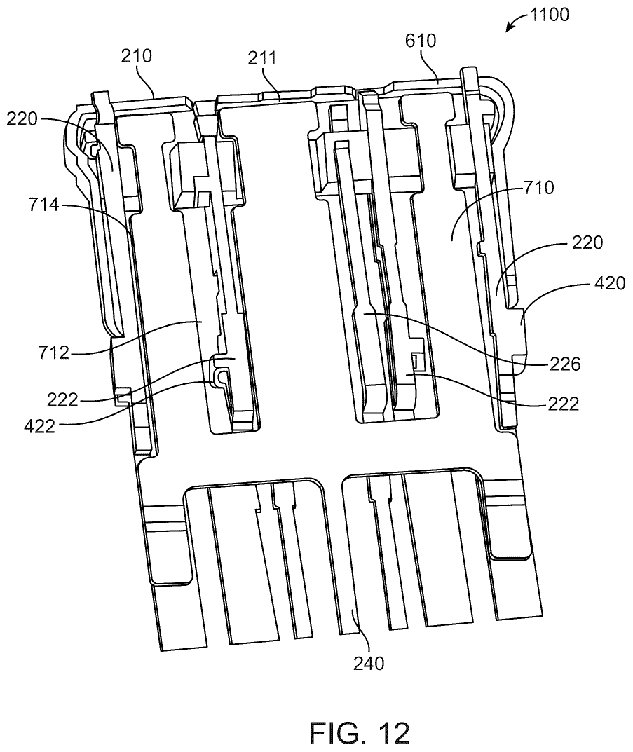

CC1 contact 226 and CC2 contact 224 can be connection detect contacts that are in compliance with USB Type-C, though these contacts can be other contacts in other embodiments of the present invention. Tongue 210 can further support side ground contacts 260 on each end. Tongue 210 can be supported by housing 250. Ground contacts 220 and 221 can terminate at single ends 230, while VBUS contacts 222 and 223 can terminate at single ends 232. CC1 contact 226 can terminate in end 236, while CC2 contact 224 can terminate in end 234. A center ground plate 710 (shown in FIG. 12) can terminate in one or more ends 240. Some or all of ends 230, 232, 234, 236, and 240 can be surface-mount contacting portions, through-hole contacting portions, or other type of end.

FIG. 12 illustrates a portion of the tongue of FIG. 11. Tongue 210 in connector receptacle 1100 can include center ground plate 710. Center ground plate 710 can include openings 712 for VBUS contacts 222 and CC1 contact 226. Center ground plate 710 can include notches 714 for ground contacts 220. Openings 712 can provide passages for joining pieces 422. Notches 714 can provide clearance for joining pieces 420. Center ground plate 710 can terminate in one or more ends 240. Center ground plate 710 can be soldered, spot or laser welded, or otherwise attached to frame 610 at one or more locations 211. Ends 240 can be surface-mount contacting portions, through-hole contacting portions, or other types of ends.

In the examples shown above, data pins D+ and D− might not be included on either the top or bottom side of tongue 1310. When a Universal Serial Bus Type-C power adapter or other downstream facing port (DFP) includes connector receptacle 200 (shown in FIG. 2), the current that can be drawn by a connected USB Type-A sink or other device can be limited. Specifically, under the USB Battery Charging Specification v1.1, a current draw can be limited to 500 mA when resistances, including a short, are not detected on the data pins D+ and D− in a power adapter or DFP by a USB-Type A sink. But USB Battery Charging Specification v1.2 can allow a sink or UFP to draw up to 5 A from a power adapter or DFP when the USB Type-A sink detects that data pins D+ and D− are shorted together in the power adapter or DFP. Accordingly, embodiments of the present invention can provide connector receptacles having data pins D+ and D− where the data pins D+ and D− are shorted to each other. This can allow currents up to the higher 5 A limit to be provided by a power adapter or DFP to a USB Type-A sink.

Also, when data pins D+ and D− are not provided on a power adapter or DFP, a connected USB Type-C sink or UFP can repeatedly attempt to read data on the D+ and D− data pins, thereby consuming additional power. The inclusion of data pins D+ and D− where the data pins D+ and D− are shorted to each other can help to prevent these attempts to read data. By not attempting to read data, power can be saved by the USB Type-C sink or UFP device. Accordingly, embodiments of the present invention can provide connector receptacle tongue having D+ and D− pins that are shorted to each other. An example is shown in the following figures.

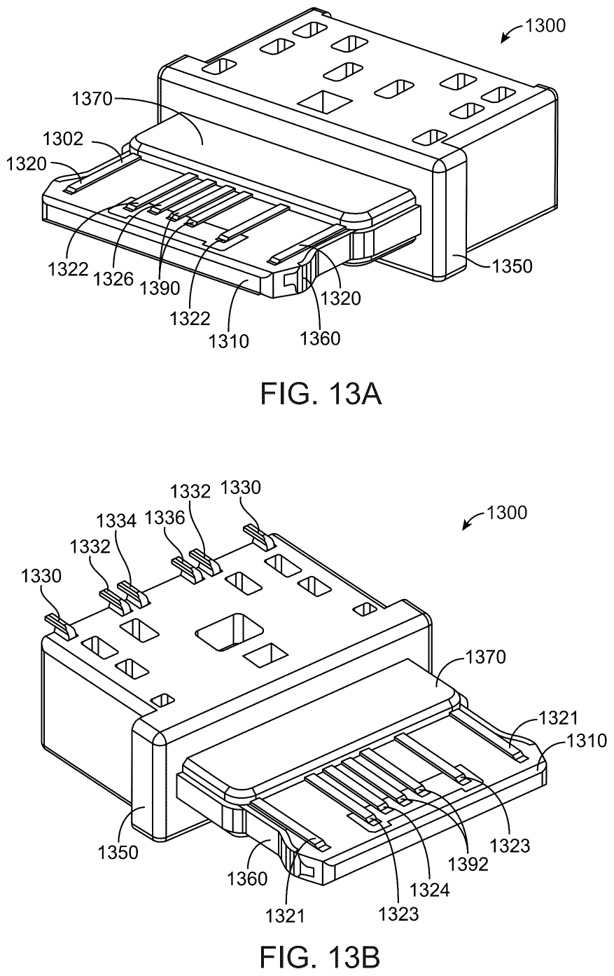

FIG. 13A and FIG. 13B illustrate a tongue for a connector receptacle according to an embodiment of the present invention. Connector receptacle 1300 can be used as connector receptacle 112, connector receptacle 122 (both shown in FIG. 1), or another connector receptacle according to an embodiment of the present invention. Tongue 1310 can include contacts 1302 including a first plurality of contacts on a top side and a second plurality of contacts on a bottom side. Specifically, tongue 1310 can include ground contacts 1320, VBUS contacts 1322, CC1 contact 1326 and D+ and D− data pins 1390 on a top side and ground contacts 1321, VBUS contacts 1323, CC2 contact 1324, and D+ and D− data pins 1392 on a bottom side. This contact arrangement can be rotationally symmetrical such that a corresponding connector insert can be inserted in either of two orientations that are rotated 180 degrees relative to each other, that is, connector receptacle 1300 can provide a reversible connection. The use of two ground contacts 1320 and two VBUS contacts 1322 can allow connector receptacle 1300 to provide or receive 240 Watts of power for a full power range for the USB Type-C specification.

CC1 contact 1326 and CC2 contact 1324 can be connection detect contacts that are in compliance with USB Type-C, though these contacts can be other contacts in other embodiments of the present invention. Tongue 1310 can further support side ground contacts 1360 on each end. Tongue 1310 can be supported by housing 1350. Housing 1350 can include tongue 1310 and surface 1370, where tongue 1310 can support contacting portions of contacts 1302 and surface 1370 can engage with front ground contacts in a corresponding connector insert (not shown.) Ground contacts 1320 and 1321 can terminate at single ends 1330, while VBUS contacts 1322 and 1323 can terminate at single ends 1332. CC1 contact 1326 can terminate in end 1336, while CC2 contact 1324 can terminate in end 1334. Some or all of ends 1330, 1332, 1334, and 1336 can be surface-mount contacting portions, through-hole contacting portions, or other type of end. In these and other embodiments of the present invention, D+ and D− data pins 1390 and D+ and D− data pins 1392 do not terminate in an end. Rather, since D+ and D− data pins 1390 are shorted and D+ and D− data pins 1392 are shorted, connector receptacle 1300 can be used in a power adapter or other DFP that can provide an increased amount of current to a sink or other UFP.

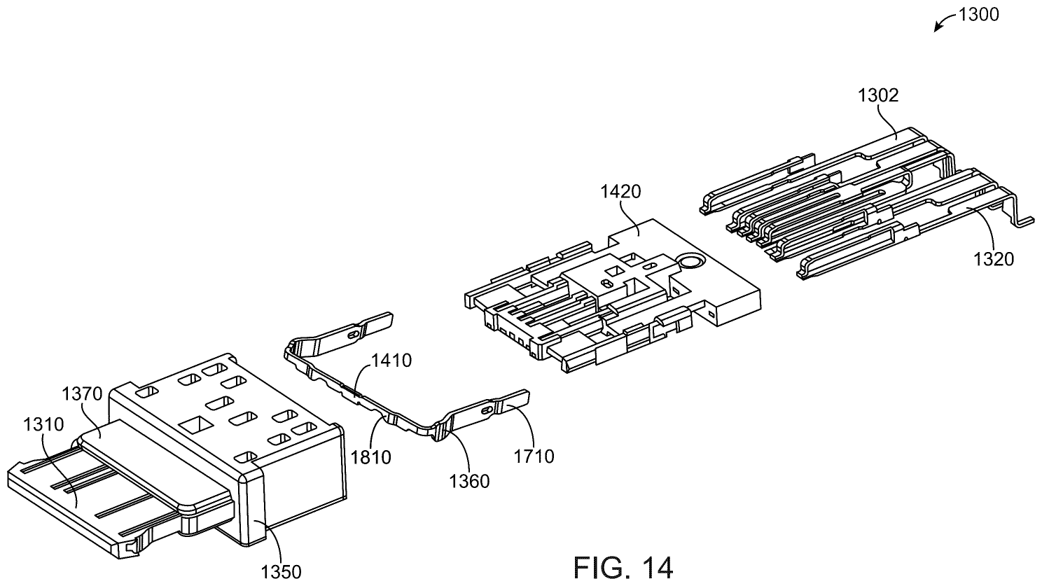

FIG. 14 is an exploded view of the tongue shown in FIG. 13. Housing 1420 can support contacts 1302 in connector receptacle 1300. For example, housing 1420 can be formed around portions of contacts 3102 by injection molding or other manufacturing procedure. Frame 1410 can be attached, for example by laser or spot-welding, to ground contacts 1320 at locations 1810 and arm sections 1710. Frame can include side ground contacts 1360. Housing 1350 can include tongue 1310 and surface 1370, where tongue 1310 can support contacting portions of contacts 1302 and surface 1370 can engage with front ground contacts in a corresponding connector insert (not shown.)

In this example, there is no center ground plate included, such as center ground plate 710 in the above examples. In these and other embodiments of the present invention, center ground plate 710 or other center ground plate can be included, or other shielding or plates can be included in its place.

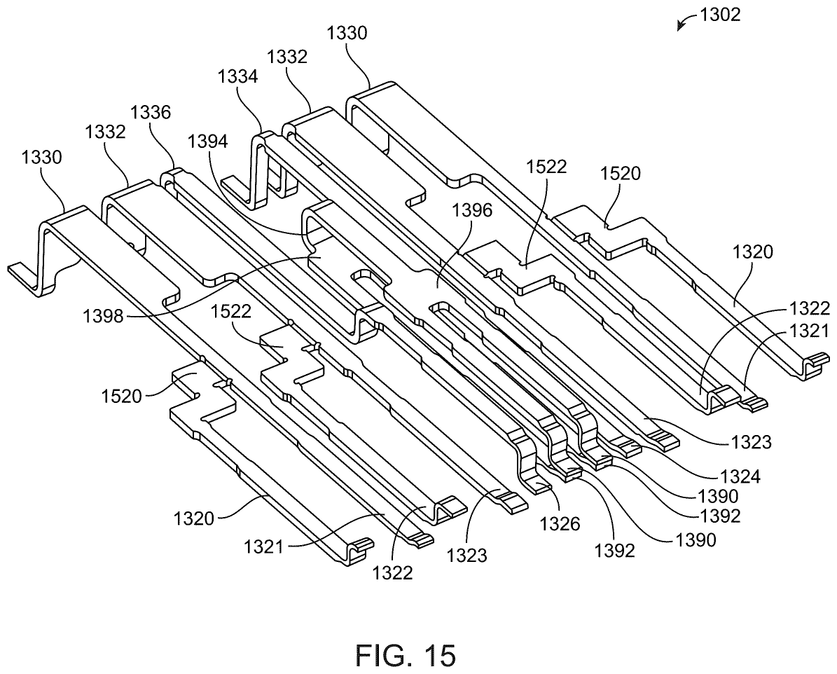

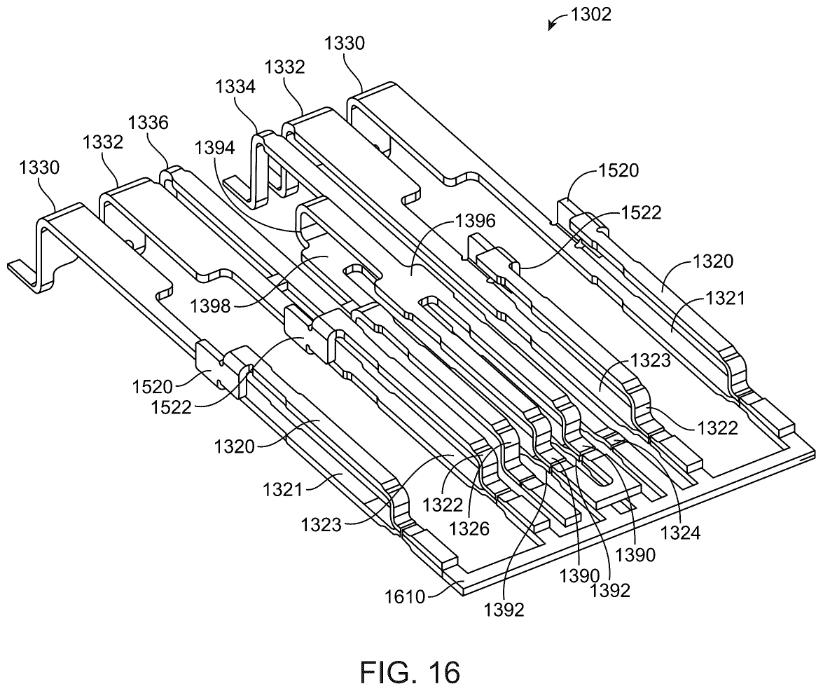

FIG. 15 illustrates a plurality of contacts according to an embodiment of the present invention. Contacts for a top side of tongue 1310 (shown in FIG. 13) can include ground contacts 1320, VBUS contacts 1322, CC1 contact 1326, and D+ and D− data pins 1390. Contacts for a bottom side of tongue 1310 can include ground contacts 1321, VBUS contacts 1323, CC2 contact 1324, and D+ and D− data pins 1392. These and other embodiments of the present invention can exploit the fact that several contacts, such as data contacts including transmit and receive pairs, as well as connector power contacts, are omitted from connector receptacle 1300 (shown in FIG. 13.) This free space can allow contacts pairs for power and ground contacts on a top and bottom of a tongue for a connector receptacle to be formed in a line next to each other. For example, ground contacts 1321 for a bottom side of tongue 1310 (shown in FIG. 13) can be formed adjacent to ground contacts 1320 for a top side of tongue 1310. Ground contacts 1321 can be joined to ground contacts 1320 via one or more joining pieces 1520. VBUS contacts 1323 for a bottom side of tongue 1310 can be formed adjacent to VBUS contacts 1322 for a top side of tongue 1310. VBUS contacts 1323 can be joined to VBUS contacts 1322 via one or more joining pieces 1522. Similarly D+ and D− data pins 1390 on a top of tongue 1310 can be joined via one or more joining pieces 1396 while D+ and D− data pins 1392 on a bottom of tongue 1310 can be joined via one or more joining pieces 1398. Joining piece 1396 can be connected to joining piece 1398 via U-bend 1394. Each pair of ground contacts 1320 and ground contacts 1321 can include can terminate in an end 1330. Each pair of VBUS contacts 1322 and VBUS contacts 1323 can terminate in an end 1332. CC1 contact 226 can terminate in end 1336. CC2 contact 1324 can terminate in end 1334. In this example, D+ and D− data pins 1390 and D+ and D− data pins 1392 do not terminate in an end, though they can terminate in an end in other embodiments of the present invention. Each end 1330, 1332, 1336, and 1334 can be a surface-mount contacting portion, through-hole contacting portion, or other contacting portion. Contacts 1302 and can be separated from carrier 1610 (shown in FIG. 16) after tongue 1310 and housing 1350 are molded.

During formation of contacts 1302, each of contacts 1302 can be attached a carrier (not shown) similar to carrier 450 (shown in FIG. 5.) This can allow the manufacturing of contacts 1302 for tongue 1310 using a single reel. That is, the carrier can be pulled from a single reel of sheet metal, which can be stainless steel or other material. All contacts 1305 and can be stamped from the same piece of metal. Once contacts 1305 have been initially formed, they can be attached to carrier 1610 (shown in FIG. 16) for further processing. For example, contacts 1302 can be stamped, they can be folded, soldered, spot or laser welded, or otherwise attached, and tongue 1310 can be molded. An example of these additional folding, stamping, and other steps is shown in the following figure.

FIG. 16 illustrates the plurality of contacts of FIG. 15 following further processing according to an embodiment of the present invention. Contacts for a top side of tongue 1310 (shown in FIG. 13) can include ground contacts 1320, VBUS contacts 1322, CC1 contact 1326, and D+ and D− data pins 1390. Contacts for a bottom side of tongue 1310 can include ground contacts 1321, VBUS contacts 1323, CC2 contact 1324, and D+ and D− data pins 1392. Contacts 1302 can be formed from a single reel. Contacts 1302 can be attached to carrier 1610, though in other embodiments of the present invention, carrier 1610 is omitted, a carrier such as carrier 450 (shown in FIG. 5) is used, or another type of carrier is used. After stamping, ground contacts 1320 can be folded over at joining pieces 1520 such that they are over ground contacts 1321. Ground contacts 1320 can be soldered, spot or laser welded, or otherwise attached to ground contacts 1321 at or near carrier 1610. Similarly, VBUS contacts 1322 can be folded over at joining pieces 1522 such that they are over VBUS contacts 1323. VBUS contacts 1322 can be soldered, spot or laser welded, or otherwise attached to VBUS contacts 1323 at or near carrier 1610. D+ and D− data pins 1390 can be joined by joining piece 1396 while D+ and D− data pins 1392 can be joined by joining piece 1398. Each D+D− data pin 1390 can be folded over at U-bend 1394 such that they are over corresponding D+D− data pins 1392. Each D+D− data pin 1390 can be soldered, spot or laser welded, or otherwise attached to corresponding D+D− data pins 1392 at or near carrier 1610. Each pair of ground contacts 1320 and ground contacts 1321 can include can terminate in an end 1330. Each pair of VBUS contacts 1322 and VBUS contacts 1323 can terminate in an end 1332. CC1 contact 226 can terminate in end 1336. CC2 contact 1324 can terminate in end 1334. In this example, D+ and D− data pins 1390 and D+ and D− data pins 1392 do not terminate in an end, though they can terminate in an end in other embodiments of the present invention. Each end 1330, 1332, 1336, and 1334 can be a surface-mount contacting portion, through-hole contacting portion, or other contacting portion.

In this example, tongue 1310 and housing 1350 (shown in FIG. 13) can be molded in a single shot. In these and other embodiments of the present invention, tongue 1310 and housing 1350 can be formed using more than one shot. For example, a first shot can be used to form a molding portion to align and hold the various contacts in position during the formation of tongue 1310 and housing 1350.

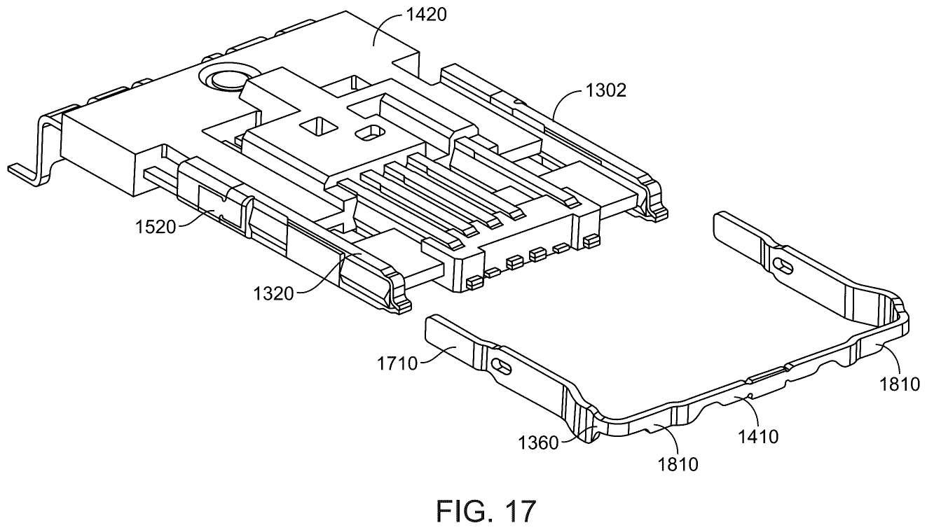

FIG. 17 is an exploded view of a portion of the tongue shown in FIG. 13. Housing 1420 can be formed around contacts 1302. Carrier 1610 (shown in FIG. 16) can be removed. Frame 1410 can include arm sections 1710. Frame can include side ground contact 1360. Frame 1410 can be attached to joining piece 1520 of ground contact 1320 at arm sections 1710. Frame 1410 can be attached to front edges of ground contacts 1320 at locations 1810.

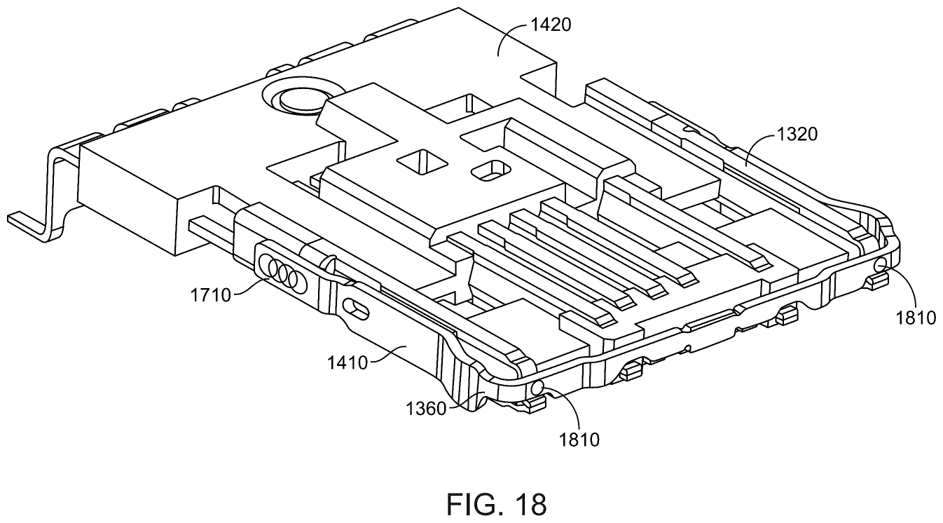

FIG. 18 illustrates a portion of the tongue of FIG. 13. Contacts 1302 can be supported by housing 1420. In this example, frame 1410 has been attached to ground contacts 1320. Specifically, frame 1410 can be attached to joining piece 1520 (shown in FIG. 17) of ground contact 1320 at arm sections 1710. Frame 1410 can be attached to front edges of ground contacts 1320 at locations 1810. Frame can further include side ground contact 1360. Housing 1350 (shown in FIG. 13) can be molded around this assembly.

These and other embodiments of the present invention can provide contacts that are the same or functionally similar on a top side as those on a bottom side of a tongue of the connector receptacle. This can help to provide a connector receptacle that provides the same functionality independent of an orientation of a connector insert plugged into the connector receptacle. This can provide a connection to an electronic device that is reversible.

As an example of this reversibility, these and other embodiments of the present invention can provide Universal Serial Bus (USB), USB Type-C connector receptacles. The contacts can be reduced to a first plurality of contacts including two ground contacts, two VBUS contacts, and a CC1 contact on a top side of a tongue and two ground contacts, two VBUS contacts, and a CC2 contact on a bottom side of the tongue of a connector receptacle. In another example the contacts can be reduced to a first plurality of contacts including two ground contacts, two VBUS contacts, a CC1 contact, and a pair of connected D+ and D− pins on a top side of a tongue and two ground contacts, two VBUS contacts, a CC2 contact, and a pair of connected D+ and D− pins on a bottom side of the tongue of a connector receptacle.

Embodiments of the present invention can provide connector structures for connector receptacles that are compliant with various standards such as Universal Serial Bus (USB), USB Type-C, High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future.

In these and other embodiments of the present invention, contacts, ground pads, and other conductive portions of a connector receptacle can be formed by stamping, progressive stamping, forging, metal-injection molding, deep drawing, machining, micro-machining, computer-numerically controlled (CNC) machining, screw-machining, 3-D printing, clinching, or other manufacturing process. The conductive portions can be formed of stainless steel, steel, copper, copper-titanium, phosphor-bronze, brass, nickel gold, copper-nickel, silicon alloys, or other material or combination of materials. They can be plated or coated with nickel, gold, or other material.

The nonconductive portions, such as tongue moldings, ribs, and other structures, can be formed using insert molding, injection molding, or other molding, 3-D printing, machining, or other manufacturing process. The nonconductive portions can be formed of silicon or silicone, polyimide, glass nylon, polycarbonate, rubber, hard rubber, plastic, nylon, liquid-crystal polymers (LCPs), ceramics, thermoplastic elastomers (TPE) or other nonconductive material or combination of materials.

Embodiments of the present invention can provide connector receptacles that can be located in various types of devices, such as tablet computers, laptop computers, desktop computers, all-in-one computers, cell phones, storage devices, wearable-computing devices, portable computing devices, portable media players, navigation systems, monitors, remotes, adapters, and other devices.

While embodiments of the present invention are well-suited to use in connector receptacles, these and other embodiments of the present invention can be utilized in connector inserts and other types of connectors as well. Reference numbers are used here in a consistent manner among the various figures.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A connector receptacle comprising:
a tongue having a top side and a bottom side;
a first plurality of contacts on the top side of the tongue, the first plurality of contacts comprising a first contact;
a second plurality of contacts on the bottom side of the tongue, the second plurality of contacts comprising a second contact; and
a first joining piece connecting the first contact to the second contact, wherein the first joining piece is bent such that the second contact is positioned below the first contact.

2. The connector receptacle of claim 1 wherein the second contact is positioned directly below the first contact.

3. The connector receptacle of claim 2 wherein the first contact and the second contact are joined and terminate in a single end.

4. The connector receptacle of claim 3 wherein the single end is a surface-mount contacting portion.

5. The connector receptacle of claim 3 wherein the single end is a through-hole contacting portion.

6. The connector receptacle of claim 3 wherein the first plurality of contacts and the second plurality of contacts are formed as a single piece including a carrier during manufacturing of the connector receptacle.

7. The connector receptacle of claim 6 wherein the carrier is removed during manufacturing of the connector receptacle.

8. The connector receptacle of claim 3 further comprising a center ground plate having a first opening, wherein the first joining piece passes through the first opening.

9. The connector receptacle of claim 1 wherein the connector receptacle is a Universal Serial Bus Type-C connector receptacle and wherein the first plurality of contacts comprises two ground contacts, two VBUS contacts, and a CC1 contact, and the second plurality of contacts comprises two ground contacts, two VBUS contacts, and a CC2 contact.

10. The connector receptacle of claim 9 wherein the first plurality of contacts further comprises D+ and D− data pins, where the D+ and D− data pins are shorted together.

11. The connector receptacle of claim 10 wherein the second plurality of contacts further comprises D+ and D− data pins, where the D+ and D− data pins are shorted together.

12. A plurality of contacts for a connector receptacle, the plurality of contacts comprising:
a first plurality of contacts to be positioned on a top side of a tongue of the connector receptacle; and
a second plurality of contacts to be positioned on a bottom side of the tongue of the connector receptacle,
wherein the first plurality of contacts and the second plurality of contacts are attached to a carrier.

13. The plurality of contacts of claim 12 wherein the first plurality of contacts and the second plurality of contacts are all the contacts to be positioned on the top side and the bottom side of the tongue of the connector receptacle.

14. The plurality of contacts of claim 12 wherein the first plurality of contacts comprises a first contact and the second plurality of contacts comprises a second contact, and wherein the first contact and the second contact terminate in a single end.

15. The plurality of contacts of claim 14 wherein the single end comprises a surface-mount contacting portion.

16. The plurality of contacts of claim 15 further comprising a first joining piece connecting the first contact and the second contact.

17. The plurality of contacts of claim 16 wherein the second contact is laser welded the first contact.

18. A method of manufacturing a connector receptacle, the method comprising:
stamping a metallic sheet to form a first plurality of contacts, a second plurality of contacts, and a carrier attached to each of the first plurality of contacts and the second plurality of contacts; and
molding a tongue around portions of the first plurality of contacts and the second plurality of contacts such that the first plurality of contacts are located on a top side of the tongue and the second plurality of contacts are located on a bottom side of the tongue.

19. The method of claim 18 further comprising detaching the carrier from the first plurality of contacts and the second plurality of contacts.

20. The method of claim 19, further comprising, before molding the tongue:
bending a joining piece between a first contact in the first plurality of contacts and a second contact in the second plurality of contacts such that the second contact is directly below the first contact after the tongue is molded.
